(19) United States
(12) Patent Application Publication
(10) Pub. No.: US 2026/0347161 A1
(43) Pub. Date: Nov. 5, 2026

(54) ARRANGEMENT FOR OPENING A GLASS AMPOULE

(71) Applicant: Michael LUKOWSKY, Bochum (DE)

(72) Inventor: Michael LUKOWSKY, Bochum (DE)

(21) Appl. No.: 19/486,380

(22) PCT Filed: May 6, 2024
(86) PCT No.: PCT/DE2024/100406

§ 371 Date: Nov. 21, 2025

(30) Foreign Application Priority Data
May 24, 2023 (DE) 202023102885.3

(51) Int. Cl. B67B 7/92

(52) U.S. Cl. CPC B67B 7/92

(57) ABSTRACT

The invention relates to an arrangement for opening a glass ampoule, comprising an ampoule stand and optionally a handpiece, wherein: the ampoule stand has at least one opening for receiving a glass ampoule, and a head of the glass ampoule protrudes from the at least one opening when the glass ampoule is disposed in the at least one opening; the direction of longitudinal extension of the glass ampoule is at an angle of less than 90° and greater than 0° to the horizontal when the glass ampoule is disposed in the at least one opening; the handpiece is a separate component and has a gripping surface and a cavity; the cavity can be slipped over the head of the glass ampoule, such that the head breaks off of the glass ampoule when the handpiece is bent relative to the ampoule stand.

### RELATED APPLICATIONS

The present application is a National Phase of International Application Number PCT/DE2024/100406, filed May 6, 2024, and claims priority of German Application Number 20 2023 102 885.3 filed May 24, 2023.

### FIELD

Aspects of this disclosure relate to arrangements and corresponding devices for opening a glass ampoule, comprising an ampoule stand and a handpiece.

### BACKGROUND

Glass ampoules are used to hold, for example, a medication, for example in liquid form. In some cases, medication is withdrawn from the glass ampoule using a syringe. To do this, the head of the glass ampoule is opened. To open the glass ampoule, the head is separated from the container of the glass ampoule. This is done by a breaking process. Injuries may occur in the process.

Therefore, various devices have been used for opening glass ampoules. For example, in DE 8 614 635 U1 a device is described in which the head of a glass ampoule can be inserted into an opening in the device and the head of the glass ampoule is broken off by relative movement (bending of the ampoule container).

A similar device is described in DE 8 503 511 U1.

There are also more mobile ampoule openers. For example, a type of handpiece is described in EP 1 293 474 B1. The head of the glass ampoule is inserted into the handpiece and then the head of the glass ampoule is broken off by bending the head relative to the ampoule body. A similar device is described in EP 0 234 206 A2.

Ampoule openers are described in U.S. Pat. No. 3,380,636 A and SE 1 950 414 A1.

A disadvantage of the ampoule openers discussed above is that their use involves both hands of the user, and the glass ampoule is held in the user's hand. In some situations, for example where laws or regulations govern the hygiene of handling medical devices, such contact of the user's hand with the glass ampoule may call for subsequent further disinfection.

### SUMMARY

At least some embodiments described herein provide for opening glass ampoules easily, effectively and safely. At least some embodiments enable hygiene standards to be effectively complied with.

At least some embodiments provide an arrangement for opening a glass ampoule.

Various embodiments are set forth in the following description.

In at least some embodiments, an arrangement for opening a glass ampoule comprises an ampoule stand and a handpiece. The ampoule stand has at least one opening for receiving a glass ampoule. The container or main body of the glass ampoule is inserted into the opening in such a way that at least the head of the glass ampoule protrudes beyond the opening. In at least some embodiments, the opening is a sleeve-like opening or a hole, at least in sections of a length of the opening. In at least some embodiments, the ampoule stand is block-shaped. The opening itself is, in some examples, made as a blind hole or other milled recess in the ampoule stand. In at least some embodiments, the ampoule stand is configured such that the ampoule is positioned in the ampoule stand at an angle of 20° to 40°, for example 25° to 35°, for example 30° to 34° relative to a horizontal. The ampoule is thus positioned in the opening in the ampoule stand at an angle to the horizontal, which is beneficial for the glass ampoule and for the liquid contained in the glass ampoule, as discussed below.

The protruding head of the glass ampoule is able to be safely broken off when the ampoule is positioned at an angle to the horizontal in the ampoule stand. For breaking off the head of the glass ampoule, the arrangement according to at least some embodiments further provides a handpiece. In at least some embodiments, the handpiece is sleeve-shaped. The sleeve-shaped part or cavity of the handpiece is slipped over the head, or at least in longitudinal sections over the head of the glass ampoule. By bending the handpiece relative to the ampoule stand, the head breaks off from the glass ampoule. In at least some embodiments, the handpiece has a rear gripping region and a front sleeve-shaped region. The handpiece helps to reduce the risk of injury and simplifies the operation of opening the ampoule. Further, by extending the handpiece, the head can be broken off with less force according to the lever principle.

In at least some embodiments, the glass ampoule is positioned with the ampoule body at an angle to the horizontal, for example in the aforementioned angle range, such that the liquid of the glass ampoule remains in the glass ampoule itself after the head is broken off. After breaking off the head, a user, for example a treating doctor, can insert a syringe or an injection needle of a syringe directly into the open ampoule opening and then withdraw the liquid from the glass ampoule by pulling up the syringe. On the one hand, this offers significant user comfort, as the open ampoule does not have to be held. At the same time, hygiene standards can be met, since the ampoule itself is no longer touched with the palms of the hands after the ampoule has been opened. Re-disinfection of the ampoule and/or hands and/or gloves of the person using it, for example the attending physician or an assistant, is avoided. The ampoule head can be broken off without the ampoule being picked up by hand. Further, the liquid can be withdrawn from the ampoule using an injection needle while complying with all hygiene standards and regulations. In at least some embodiments, the arrangements and corresponding devices for opening a glass ampoule help to reduce a risk of injury. By comparison, if the ampoule is held in the hand and a cannula is inserted into the opening of the ampoule to withdraw the contents of the ampoule using the cannula, there is a possibility that the cannula accidentally misses the opening during this process, which risks injuring the fingers/hand holding the ampoule.

In at least some embodiments, the opening (or openings) in the ampoule stand is a blind hole that does not run through the entire length of the ampoule stand. In at least some embodiments, an upper front region of the opening is not covered and is therefore exposed. This allows for a user to recognize, at least in part, what color or inscription is on the ampoule. This also allows, due to the transparency of the ampoule itself, the liquid, or at least the fill level of the liquid in the ampoule, to be seen. Glass ampoules usually have a predetermined breaking point on their neck, the position of which is marked by a dot on the head of the ampoule. In at least some embodiments, the ampoule stand is configured such that the blind hole does not extend over the full length of the ampoule, which allows, for example, the ampoule to be easily turned into the corresponding position with the finger so that the predetermined breaking point is facing upwards. This is useful when opening the ampoule.

In at least some embodiments, at least two openings are arranged next to each other in the ampoule stand, for example, a total of 2 to 11 openings are arranged in the ampoule stand, for example 3, 4, 5 or 6 openings are arranged next to one another. In at least some embodiments, at least two openings are arranged next to each other, and thus two glass ampoules can be arranged next to each other in the ampoule stand and opened. For example, in a case where a medical indication calls for two different preparations or medications, both medications can be prepared or withdrawn or then administered directly. In at least some embodiments, the ampoule stand is configured such that multiple ampoules can be arranged next to each other so that appropriate medications are stored in the stand, which is useful, for example, in the case that the contents of a glass ampoule are not sufficient or different medications are used one after the other. This also makes it possible to aspirate different contents of ampoules, for example medications, into the same syringe and thus mix them together.

In at least some embodiments, the opening in the ampoule stand is a shape that is other than a round or circular shape of glass ampoule. In at least some embodiments, the opening is, for example, square and sized to accommodate the glass ampoule. In at least some embodiments, openings with rectangular cross-section are used, for example for plastic ampoules, which themselves have a rectangular cross-section. These can also be placed in the ampoule stand. In at least some embodiments, the process of opening a plastic ampoule does not involve the use of the handpiece. However, the plastic ampoule is positioned in the stand to extract the liquid from the plastic ampoule, which can be done without contact such that the ampoule itself does not need to be touched or held with hands. Rather, the person using it, for example the attending physician, can extract the liquid directly using an injection needle or syringe.

In at least some embodiments, at least two openings of the ampoule stand have different diameters from one another. In at least some embodiments, glass ampoules of different sizes, for example with different capacities, can be placed in the ampoule stand. In at least some embodiments, a first opening has a diameter of more than 14 mm and less than 20 mm, for example approximately 15 mm. In at least some embodiments, a second opening has a diameter of more than 10 mm and less than 15 mm, for example more than 11 mm and less than 13 mm, for example approximately 12 mm.

In at least some embodiments, the depth of an opening, for example relative to a front breaking edge of the ampoule stand, is at least 25 mm and less than 35 mm, for example in the case of an opening having a diameter of approximately 30 mm. In at least some embodiments, the depth of a larger-diameter opening is for example greater than 30 mm and less than 50 mm, for example approximately 40 mm.

In at least some embodiments, the ampoule stand includes a base shoulder, for example on a front lower edge of the ampoule stand and protruding beyond an edge or front of the ampoule stand. In at least some embodiments, the ampoule stand is configured such that the ampoule stand stands securely during storage and during use when carrying out the movement to break off the head of the glass ampoule. In at least some embodiments, the base shoulder has a depth of more than 10 mm, for example more than 20 mm, for example approximately 30 mm. When angled downwards in relation to the vertical direction, the ampoule stand is less likely to tip forwards.

In at least some embodiments, to further support the bending movement, an upper edge is angled, for example on the front side of the ampoule stand. In at least some embodiments, the bending takes place for example at an angle of approximately 10° to 50°, for example 20° to 40°, for example approximately 25° to 35° to a vertical. This helps make it possible to carry out the bending or breaking movement to break off the head of the glass ampoule effectively and reliably when the ampoule is obliquely supported relative to the horizontal.

In at least some embodiments, the ampoule stand is made of a plastic, for example solid plastic. On the one hand, it has been found that the device can be easy to handle due to a low overall weight. At the same time, in the case that the ampoule stand is designed as a solid block, the ampoule stand has sufficient weight to help ensure a secure stand and stability when performing the bending movement.

In at least some embodiments, the ampoule stand is at least partially hollow, for example as a plastic injection-molded component. In at least some embodiments, a weight is incorporated into the base. In at least some embodiments, there is an increased proportion of plastic material, and a metal plate or a wooden plate is incorporated to help ensure a secure stand, for example when performing the bending movement. The ampoule stand can also be made hollow from below.

### BRIEF DESCRIPTION OF THE DRAWINGS

Further advantages, features, characteristics and aspects of at least some embodiments are set forth in the following description and described in connection with the schematic figures. In the figures,

FIG. 1 shows an ampoule stand according to at least some embodiments in perspective view with a glass ampoule,

FIG. 2 shows the ampoule stand in side view with inserted glass ampoule,

FIG. 3 shows the ampoule stand in side view with inserted glass ampoule and applied handpiece,

FIG. 4 shows the execution of the bending movement,

FIG. 5 shows the ampoule stand in side view with opened glass ampoule and inserted syringe for extracting the liquid.

In the figures, the same reference numerals are used for identical or similar objects, although a repeated description may be omitted for reasons of simplification.

### DETAILED DESCRIPTION

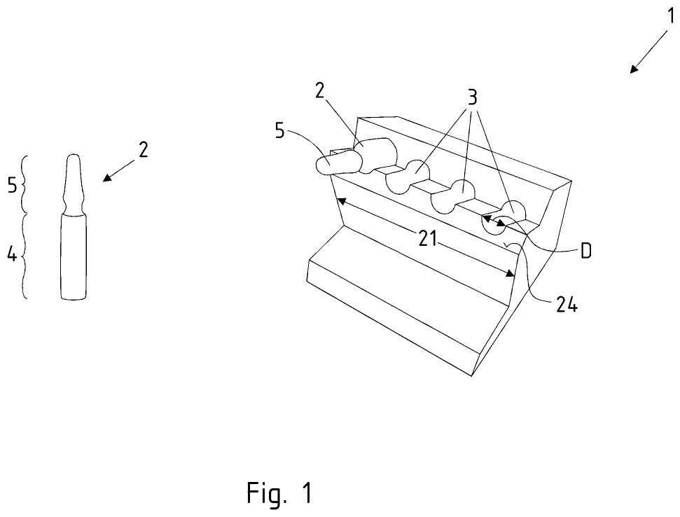

FIG. 1 shows an ampoule stand 1 according to at least some embodiments with an inserted glass ampoule 2. The ampoule stand 1 has multiple openings 3. A glass ampoule 2, also shown in FIG. 1, is inserted with a housing 4 or ampoule body of the ampoule positioned into an opening 3 of the ampoule stand 1. The head 5 of the glass ampoule 2 protrudes from the opening 3.

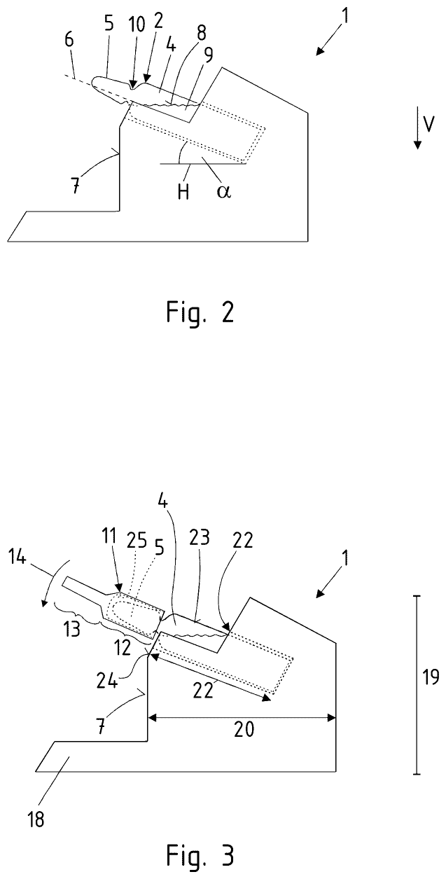

This can be understood with reference to the side view shown in FIG. 2. The ampoule is supported such that a longitudinal extension 6 of the ampoule body is at an angle α to a horizontal. The angle α is 20° to 40°, for example 25° to 35°, for example 30° to 34°. With the longitudinal extension 6 of the ampoule extending at an angle relative to a horizontal, or with the ampoule body of the ampoule supported at an angle relative to a horizontal, the head 5 of the ampoule is opposite a front side 7 of the ampoule stand 1.

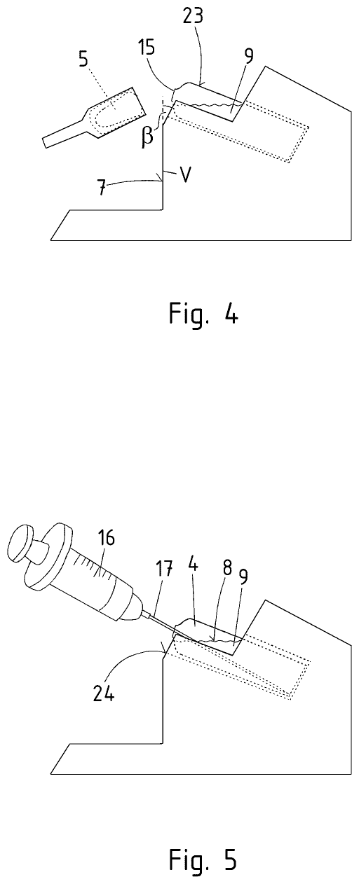

A filling level 8 indicates a level of the liquid 9 contained in the ampoule. The liquid thus stored in the ampoule is positioned in the vertical direction V below a constriction 10 between the housing 4 and the head 5 of the glass ampoule 2. In the case of the broken-off head 5 shown in, for example, FIG. 4, the liquid 9, for example the fill level 8 of the liquid 9, remains below a break-off edge 15. Thus, the liquid 9, shown in FIG. 4, remains within the glass ampoule 2 and does not come into contact with the environment due to possible spill over.

FIG. 3 shows a handpiece 11 and the ampoule stand 2 according to at least some embodiments. In FIG. 3, the handpiece 11 is placed on the protruding head 5. For this purpose, the handpiece 11 has a front sleeve-shaped section 12 with a cavity 25, with which the handpiece 11 engages over the head 5. In a portion of the handpiece 11 corresponding to the longitudinal extension 6 of the ampoule housing 4 or ampoule body, the handpiece 11 includes a grip section 13, with which the handpiece 11 can be grasped with a hand or fingers. If a bending movement 14 is now carried out, for example downwards in the vertical direction V, the head 5 of the glass ampoule 2 breaks, as shown in FIG. 4, and a breaking edge 15 remains. However, the glass ampoule 2 no longer needs to be touched or logistically relocated in any other way after the opening process. Referring to the illustration in FIG. 5, a syringe 16, specifically an injection needle 17 of a syringe 16, can be used to enter the liquid 9 and to withdraw the liquid 9 from the glass ampoule 2, which is arranged at an angle relative to a horizontal. To prevent the bending movement 14 shown in FIG. 3 from causing the ampoule stand 1 to tip forward or tip over, a base shoulder 18 is further formed, wherein the base shoulder 18 protrudes from the front side 7 of the ampoule stand 1, for example by approximately 2 cm to 4 cm. The entire ampoule stand 1 furthermore has a total height 19 of approximately more than 4 cm, but less than 8 cm, for example between 5 cm and 6 cm. Furthermore, the main body of the ampoule stand 1 has a depth 20 of for example more than 3 cm, but less than 8 cm, for example between 4 cm and 6 cm, for example 5 cm. The width 21 shown in the perspective view of FIG. 1 corresponds to, for example, the number of selected openings 3. For example, in at least some embodiments, an ampoule stand 1 with only two openings 3 is narrower, while an ampoule stand 1 with 3, 4, or 5 openings 3 is correspondingly wider. A respective opening 3 itself has a diameter which lies within the diameter ratio described above. For example, two openings 3 arranged next to each other can have different diameters. Furthermore, a stepped shoulder is formed on the upper side 23 of the ampoule stand 1. Due to the stepped shoulder, the respective opening 3 is not completely formed over the entire depth 22 of the opening 3. Thus, the upper side 23 of the glass ampoule 2 remains visible. On the one hand, any inscription on the glass ampoule 2 can be accessed, and furthermore, the respective fill level 8 of the glass ampoule 2 can be determined optically. In order to support the bending movement 14 shown in FIG. 3, an upper edge surface 24 of the front side 7 is also angled, as shown in FIG. 4, for example by an angle β of 10° to 50°, for example 20° to 40°, for example 25° to 35° relative to the vertical V shown in FIG. 4. Thus, as shown in FIGS. 3 and 4, the handpiece 11 can be placed and the bending movement can be carried out while reducing the possibility of jamming or the like. The head 5 of the glass ampoule 2 can thus be broken off in a reproducible way.

1. An arrangement for opening a glass ampoule, comprising:
an ampoule stand; and
a handpiece,
wherein:
the ampoule stand has at least one opening for receiving a glass ampoule,
the at least one opening is arranged such that a longitudinal axis of the at least one opening extends at an angle of 20 to 40 degrees relative to a horizontal,
the at least one opening is configured such that a head of the glass ampoule protrudes from the at least one opening when the glass ampoule is arranged in the at least one opening, and a direction of longitudinal extension of the glass ampoule is at an angle of less than 90° and greater than 0° to the horizontal when the glass ampoule is disposed in the at least one opening,
the handpiece is a separate component and has a gripping surface and a cavity, and
the cavity can be slipped over the head of the glass ampoule, such that the head breaks off of the glass ampoule when the handpiece is bent relative to the ampoule stand.

2. The arrangement according to claim 1, wherein:
the longitudinal axis of the at least one opening extends at an angle of 25 to 35 degrees to the horizontal.

3. The arrangement according to claim 1, wherein:
the at least one opening includes at least two openings arranged next to one another.

4. The arrangement according to claim 3, wherein:
the at least two openings have different diameters from one another.

5. The arrangement according to claim 1, wherein:
the ampoule stand includes a base shoulder protruding on a front side of the ampoule stand.

6. The arrangement according to claim 1, wherein:
the at least one opening includes a bottom that is configured to stop insertion of the glass ampoule into the ampoule stand,
the ampoule stand includes, at the at least one opening, a stepped shoulder,
the stepped shoulder includes a step that partially exposes and partially encloses a longitudinal portion of the glass ampoule when the glass ampoule is disposed in the at least one opening, and
a lower part of the stepped shoulder extends away from the bottom of the at least one opening.

7. The arrangement according to claim 1, wherein:
on a front side of the ampoule stand, an upper edge surface of the ampoule stand is angled relative to a vertical direction.

8. The arrangement according to claim 1, wherein:
the handpiece has a rear gripping region and a front sleeve-shaped section.

9. The arrangement according to claim 1, wherein:
the ampoule stand includes a form-fitting receptacle for the handpiece.

10. The arrangement according to claim 1, wherein:
the ampoule stand comprises plastic.

11. The arrangement according to claim 1, wherein:
the at least one opening includes 2 to 11 openings arranged next to one another.

12. The arrangement according to claim 11, wherein:
the at least one opening includes 3, 4, 5 or 6 openings arranged next to one another.

13. The arrangment according to claim 2 wherein the longitudinal axis of the at least one opening extends at an angle of 30 to 34 degrees to the horizontal.

14. The arrangement according to claim 7, wherein:
the upper edge surface of the ampoule stand is angled at an angle of 10 to 50 degrees relative to the vertical direction.

15. The arrangement according to claim 14, wherein:
the upper edge surface of the ampoule stand is angled at an angle of 20 to 40 degrees relative to the vertical direction.

16. The arrangement according to claim 15, wherein:
the upper edge surface of the ampoule stand is angled at an angle of 25 to 35 degrees relative to the vertical direction.

17. The arrangement according to claim 9, wherein:
the form-fitting receptacle for the handpiece includes a handpiece opening that is configured to support an outer portion of the handpiece.
